(19) United States
(12) Patent Application Publication
(10) Pub. No.: US 2025/0122368 A1
(43) Pub. Date: Apr. 17, 2025

(54) SILICA-COATED STIMULUS-RESPONSIVE POLYMERIC NANOPARTICLES

(71) Applicant: REGENTS OF THE UNIVERSITY OF MINNESOTA, Minneapolis, MN (US)

(72) Inventors: Christy L. Haynes, Minneapolis, MN (US); Beza Tuga, Minneapolis, MN (US); Hyunho Kang, Cranford, NJ (US)

(21) Appl. No.: 18/916,866

(22) Filed: Oct. 16, 2024

Related U.S. Application Data
(60) Provisional application No. 63/544,418, filed on Oct. 16, 2023.

(51) Int. Cl. C08L 51/00; B82Y 30/00

(52) U.S. Cl. CPC C08L 51/003; B82Y 30/00; C08L 2203/02; C08L 2207/53

(57) ABSTRACT

A nanoparticle generally includes a stimulus-responsive polymer core and a silica coating disposed on at least a portion of the core. Methods of forming nanoparticles. Methods of administering nanoparticles to a target subject.

### CROSS REFERENCE TO RELATED APPLICATIONS

This application claims the benefit of U.S. Provisional Patent Application No. 63/544,418, filed Oct. 16, 2023, the disclosure of which is incorporated by reference herein in its entirety.

### GOVERNMENT FUNDING

This invention was made with government support under CHE2001611 awarded by the National Science Foundation. The government has certain rights in the invention.

### SUMMARY

This disclosure describes, in one aspect, a nanoparticle. The nanoparticle includes a stimulus-responsive polymer core and a silica coating disposed on at least a portion of the polymer core.

In one or more embodiments, the stimulus-responsive polymer swells in response to a stimulus. In one or more embodiments, the stimulus-responsive polymer includes a pH-responsive polymer, a redox-responsive polymer, a light-responsive polymer, a temperature responsive polymer, or any combination thereof. In one or more embodiments, the pH-responsive polymer includes poly(acrylic acid), poly(methacrylic acid), poly(ethacrylic acid), poly(2-dimethylamino)ethyl methacrylate, poly(2-dipropylamino)ethyl methacrylate, poly(2-diisopropylamino)ethyl methacrylate, poly(2-dimethylamino)ethyl acrylate, or any combination thereof. In one or more embodiments, the redox-responsive polymer includes polyphenylene sulfide. In one or more embodiments, the light-response polymer includes poly(N-isopropylacrylamide) (pNIPAAm) copolymers comprising pendant benzophenone units. In one or more embodiments, the temperature responsive polymer includes poly(N-isopropylacrylamide); poly[2-(dimethylamino)ethyl methacrylate] (pDMAEMA); hydroxypropylcellulose; poly(vinylcaprolactam); poly-2-isopropyl-2-oxazoline; polyvinyl methyl ether, or any combination thereof.

In one or more embodiments, the nanoparticle further includes a second coating disposed on the stimulus-responsive polymer core. In one or more embodiments, at least a portion of the second coating is in direct contact with the stimulus-responsive polymeric core and the silica coating is in direct contact with at least a portion of the second coating.

In one or more embodiments, the nanoparticle further includes at least one species of cargo molecule loaded into or onto the nanoparticle. In one or more embodiments, the cargo molecule is loaded into the core, incorporated into the silica coating, attached to the surface of the silica coating, or any combination thereof. In one or more embodiments, the cargo molecules includes a detectable marker, genetic material, fertilizer, an immunostimulant, or any combination thereof.

In another aspect, the present disclosure describes a composition that includes plurality of the nanoparticles of any previous aspect or embodiment and a carrier. In one or more embodiments, the carrier is a liquid or a solid.

In another aspect, the present disclosure describes a method of preparing the nanoparticle of any previous aspect or embodiment. The method includes preparing a polymer core and coating at least a portion of the polymer core with a silica coating.

In another aspect, the present disclosure describes a method of delivering silicic acid to a target subject. The method includes administering a nanoparticle to the target subject. The nanoparticle can be a nanoparticle of any previous aspect or embodiment. The method further includes allowing a stimulus to react with the nanoparticle, thereby causing the polymer core to swell, fracturing the silica shell into fragments comprising silicic acid. The method further includes allowing silicic acid to be released from the fragments.

In one or more embodiments, the target subject includes a stimulus to which the stimulus-responsive polymer responds.

In one or more embodiments, the target subject does not include a stimulus to which the stimulus-responsive polymer responds. In one or more embodiments, the method further includes providing a stimulus to which the stimulus-responsive polymer responds.

In one or more embodiments, the stimulus is pH, redox potential, temperature, or light.

In one or more embodiments, target subject is a plant. In one or more embodiment, administering a nanoparticle to the target subject includes administering the nanoparticles or composition containing the same to the plant, a media in contact with the plant, or both.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1. Schematic illustration of silica-coated swelling polymers. Poly(2-diethylamino)ethyl methacrylate) (pDEAEMA) polymer core swells in acidic media. When coated with a silica-based coating, swelling of the polymer core disrupts the silica coating and creates silica fragments.

FIG. 2. Swelling mechanism of pH-responsive polymers.

FIG. 3. Silica-coated swelling polymer nanoparticle design. An exemplary embodiment is shown. A swelling polymer (pDEAEMA) core is first prepared and then a bifunctional polymer is added that facilitates adding a silica coating (e.g., 3-(trimethoxysilyl)propyl methacrylate; MPS). Then, the silica coating is added (e.g., tetraethyl orthosilicate; TEOS).

FIG. 4. An exemplary free radical polymerization method for pDEAEMA synthesis.

FIG. 5. Swelling polymeric nanoparticle behavior. (A) Swelling of an exemplary polymer core (pDEAEMA) is instantaneous and maintained over the course of 50 minutes. The plot represents average of four replicates at pH 4.6. (B) Swelling behavior of the exemplary polymer core (pDEAEMA) is reversible. The swelled polymer cores de-swell in basic media.

FIG. 6. Polymer swelling behavior. Swelling of exemplary pDEAEMA polymer cores occurs sharply near the pKb region of the polymer (pH 7.0-7.3).

FIG. 7. Polymer swelling behavior is maintained when the pH-responsive swelling polymer (e.g., pDEAEMA) is copolymerized with a bifunctional polymer that facilitates adding a silica coating (e.g., MPS).

FIG. 8. Biocompatibility of polymer cores. Polymer cores were applied to tomato plants in a greenhouse study. Biocompatibility was determined by assessing shoot weight. Polymer cores had no negative effect on shoot weight.

FIG. 9. Silica-coated pDEAEMA+MPS nanoparticles in neutral and acidic pH media.

FIG. 10. Elemental map showing a carbon-rich core in red (from the polymer) and a silicon shell in blue (from the silica coating).

FIG. 11. Silica coated pDEAEMA and pMMA nanoparticle size in different pH media for samples in ethanol and water. Data shows that only the swelling polymers (pDEAEMA) are increasing in size in acidic media.

FIG. 12. Silica-coated pDEAEMA+MPS nanoparticles in neutral, acidic pH media, and basic pH media.

FIG. 13. Transmission electron microscopy (TEM) images of the elemental maps shown in FIG. 10 for both as synthesized nanoparticles and acid-treated samples. There are clear pH-activated changes occurring with the acid treatment.

FIG. 14. Another perspective of the data represented in FIG. 5.

### DETAILED DESCRIPTION OF ILLUSTRATIVE EMBODIMENTS

This disclosure describes nanoscale stimulus-responsive polymeric nanoparticles that are at least partially coated in a silica shell. The size of the polymer component, the size of the silica component, the surface chemistry of the silica shell, or any combination thereof can be tailored so that the particles display desired characteristics. Upon exposure to a stimulus (e.g., a low pH environment), the polymer core swells, inducing fracture of the silica shell into small, high surface area fragments. In one or more embodiments, silicic acid (a plant-beneficial molecule) is release from the silica fragments. Any cargo contained in the polymeric core may also be released.

Sustainable agricultural solutions are needed to address the challenge of feeding the global population. One such solution is the use of nanoparticles (NPs) for sustainable agriculture. For instance, silica nanoparticles improve seed germination and alleviate stress resistance in different plant systems. As such, silica nanoparticles may serve as nano-enabled plant disease management strategies. Nanoparticles made from silica can improve stress resistance and disease resistance in plants, thereby improving overall plant health and yield. Silica nanoparticle dissolution releases silicic acid (Si(OH)₄). Plants take up and use silicon in the form of silicic acid. For example, silicon in the form of silicic acid, can reduce susceptibility of plants to disease. Without wishing to be bound by any particular theory or mode of action, silicon may reduce plant susceptibility to disease by 1) acting as a mechanical barrier deposited beneath cuticles that can prevent pathogen or pest infiltration, 2) stimulating the plants natural defense mechanisms against disease or stress, or both 1 and 2. Thus, silica nanoparticles have been used as a source of silicic acid that can increase plant health and increase resistance to disease.

Soil fumigation has long been used to protect plants. However, soil fumigants are damaging to the environment and soil microbiome. In one application of the stimulus-responsive polymeric nanoparticles described herein, silica-coated swelling polymeric nanoparticles can be used to reduce reliance on fumigants, thereby reducing the negative environmental effects of fumigants. The nanomaterials described herein can be designed to deliver silicic acid to crop plants, decreasing or eliminating the need for conventional fumigation treatment. This disclosure therefore describes, in one aspect, the design and synthesis of nanoscale silica-coated swelling polymers to serve as crop nutrients, mitigating the need for soil fumigation.

The present disclosure describes, in one aspect, a nanoparticle. The nanoparticle includes a stimulus-responsive polymer and silica. As such, the nanoparticle may be termed a stimulus-responsive, silica coated nanoparticle. The stimulus-responsive polymer may form the core of the nanoparticle. The silica may form a coating, or a shell disposed on at least a portion of the polymer core.

The term “on” when used in the context of a coating or shell disposed on a polymer core, includes both the coating or shell directly or indirectly (e.g., an intermediate coating or layer) disposed on (e.g., applied to) the polymer core. Thus, for example, a silica coating disposed on at least a portion of a polymer core constitutes a silica coating directly in contact with the polymer core, a silica coating contacting an intermediate layer or coating (e.g., a second coating) that is disposed on the polymer core, or both.

The nanoparticle can include any suitable stimulus-responsive polymer. The stimulus-responsive polymer may be responsive—e.g., undergo a change in structure and/or property—to any suitable stimulus. For example, the stimulus-responsive polymer may respond to a change in pH, redox potential, or other environmental, physical, or chemical stimulus including, but not limited to, light, ionic strength, solvent, carbon dioxide, or any combination thereof.

In one or more embodiments, the stimulus-responsive polymer may be a pH-responsive polymer that swells in response to a change in pH. The pH-responsive polymer may be any member of a group of stimulus-responsive polymers that responds to changes in the pH of a environment by undergoing structural and/or property changes including, but not limited to, surface activity, packing, size, chain conformation, solubility, and/or configuration. The term “pH-responsive polymers” is commonly used to describe polymers having ionizable acidic or basic moieties whose ionization depends at least in part on the pH of the environment.

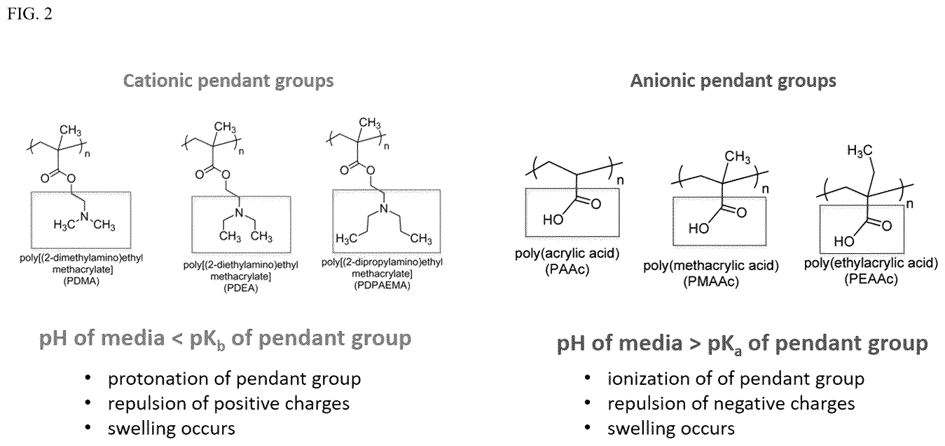

Exemplary pH-responsive polymers are shown in FIG. 2. Exemplary pH responsive polymers include, but are not limited to, poly(acrylic acid), poly(methacrylic acid), and poly(ethacrylic acid), poly-2-(diethylamino)ethyl methacrylate (pDEAEMA); poly[2-(dimethylamino)ethyl methacrylate] (pDMAEMA), poly[(2-dipropylamino)ethyl methacrylate] (pDPAEMA); poly[(2-diisopropylamino)ethyl methacrylate (pDPA); poly[(2-diethylamino)ethyl acrylamide](pDEAm), or any combination thereof.

In one or more embodiments, a pH-response polymer can swell in response to exposure to an environment having a pH greater than the pKa of the polymer, or the ionizable moieties of the polymer. Polymers that swell in response to exposure to an environment having a pH greater than the pKa of the polymer are generally acidic polymers. Upon exposure to a pH greater than the pKa of the polymer, at least some of the acidic moieties (e.g., carboxylic acid groups) of the polymer are ionized to anions (FIG. 2). The anionic groups repel each other resulting in swelling of the polymer. In one or more embodiments, the pH-response polymer has a pKa of 8.0 or less, 7.5 or less, 7 or less, 6.5 or less, 6 or less, 5.5 or less, 5 or less, 4.5 or less, 4 or less, 3.5 or less, or 3 or less. In one or more embodiments, the pH-response polymer has a pKa of 2 or more, 2.5 or more, 3 or more, 3.5 or more, 4 or more, 4.5 or more, or 5 or more, 5.5 or more, 6.0 or more, 6.5 or more, 7.0 or more, or 7.5 or more. Examples of acidic polymers include poly(acrylic acid), poly(methacrylic acid), and poly(ethacrylic acid).

In one or more embodiments, a pH-response polymer can swell in response to exposure to an environment having a pH less than the pKb of the polymer, or the ionizable moieties of the polymer. Polymers that swell in response to exposure to an environment having a pH less than the pKb of the polymer are generally basic polymers. Upon exposure to a pH less than the pKb of the polymer, at least some of the basic moieties (e.g., amines) of the polymer are ionized to cations (FIG. 2). The cationic groups repel each other resulting in swelling of the polymer. In one or more embodiments, the pH-response polymer has a pKb of 14 or less, 13 or less, 12 or less, 11 or less, 10 or less, 9.5 or less, 9 or less, 8.5 or less, 8 or less, or 7.5 or less, 7 or less, 6.5 or less, 6 or less, or 5.5 or less. In one or more embodiments, the pH-response polymer has a pKa of 5 or more, 5.5 or more, 6.0 or more, 6.5 or more, 7.0 or more, 7.5 or more, 8.0 or more, 8.5 or more, 9.0 or more, 10 or more, 11 or more 12 or more, or 14 or more. Examples of basic polymers include poly(2-dimethylamino)ethyl methacrylate, poly(2-dipropylamino)ethyl methacrylate, poly(2-diisopropylamino)ethyl methacrylate, and poly(2-dimethylamino)ethyl acrylate.

In one or more embodiments, the pH-responsive polymer can be poly-2-(diethylamino)ethyl methacrylate (pDEAEMA). pDEAEMA is a swelling polymer that enlarges in size in the presence of acidic media. pDEAEMA has a pKa near 7.5. When exposed to a pH of 7.5 or greater, at least some of the diethylamino groups become protonated. The cation groups repel each other resulting in swelling of the pDEAEMA polymer.

In one or more embodiments, the stimulus-responsive polymer may be a redox-responsive polymer that swells in response to a change in redox potential. The redox-responsive polymer may be any member of a group of stimulus-responsive polymers that responds to a change in redox potential of a solution by undergoing structural and/or property changes including, but not limited to, surface activity, chain conformation, solubility, and/or configuration. Exemplary redox-responsive polymers include, but are not limited to, polyphenylene sulfide (PPS).

In one or more embodiments, the stimulus-responsive polymer may be a light-responsive polymer that swells in response to exposure to light of a certain wavelength. The light-responsive polymer may be any member of a group of stimulus-responsive polymers that responds to exposure to light of a given wavelength by undergoing structural and/or property changes including, but not limited to, surface activity, chain conformation, solubility, and/or configuration. Exemplary light-responsive polymers include, but are not limited to, poly(N-isopropylacrylamide) (pNIPAAm) copolymers containing pendant benzophenone units. pNIPAAM and copolymers of pNIPAAM containing pendant benzophenone units may also be a temperature-responsive polymer.

In one or more embodiments, the stimulus-responsive polymer may be a temperature-responsive polymer that swells in response to a change in temperature. The temperature-responsive polymer may be any member of a group of stimulus-responsive polymers that responds to a change in temperature of a solution by undergoing structural and/or property changes including, but not limited to, surface activity, chain conformation, solubility, and/or configuration. Exemplary temperature-responsive polymers include, but are not limited to, poly(N-isopropylacrylamide); poly[2-(dimethylamino)ethyl methacrylate] (pDMAEMA); hydroxypropylcellulose; poly(vinylcaprolactam); poly-2-isopropyl-2-oxazoline; and polyvinyl methyl ether.

pDMAEMA is dually responsive to both changes in pH and changes in temperature. Therefore, pDMAEMA may be desirable for an application where dual responsiveness to pH or temperature may be desired.

Copolymers of pNIPAAM containing pendant benzophenone units may be dually responsive to both changes in light and changes in temperature. Therefore, copolymers of pNIPAAM containing pendant benzophenone units may be desirable for an application where dual responsiveness to light or temperature may be desired.

In one or more embodiments, the polymer is polymerized from one or more monomers and a crosslinking agent. As such, the polymer can be the reaction product of a polymerization reaction of one or more monomers and a crosslinker. The crosslinker can be added during polymerization, after polymerization, or both. The cross linker can be a polymer. For example, the crosslinker can be poly(ethylene glycol) dimethacrylate (PEGDMA). The number average molecular weight of a crosslinker that is a polymer may vary. For example, in one or more embodiments, the crosslinker is PEGDMA having a number average molecular weight of 200 Daltons (Da), 400 Da, or 600 Da. Other examples of crosslinkers include bis(acryloyl) cist amine and polymers thereof.

The number-average molecular weight (Mn) of a polymer the present disclosure may vary. Mn is calculated using the following equation:

$$Mn = \sum {x}_{i} {M}_{i}$$

where Mi is the mean molecular size of range i and xi is the number fraction of the total number of polymer chains that are within Mi range. Mn may be determined, for example, using size exclusion chromatography with a multi-angle light scattering detector.

In one or more embodiments, the Mn of the polymer is 1 kilodalton (kDa) or greater, 2 kDa or greater, 3 Kda or greater, 4 kDa or greater, 5 (kDa) or greater, 6 kDa or greater, 7 kDa or greater, 8 kDa or greater, 9 kDa or greater, 10 kDa or greater, 12 kDa or greater, 14 kDa or greater, 16 kDa or greater, 18 kDa or greater, 20 kDa or greater, 25 kDa or greater, 30 kDa or greater, 40 kDa or greater, 50 kDa or greater, or 75 kDa or greater. In one or more embodiments, the Mn of the polymer is 100 kDa or less, 75 kDa or less, 50 kDa or less, 40 kDa or less, 30 kDa or less, 25 kDa or less, 20 kDa or less, 18 kDa or less, 16 kDa or less, 14 kDa or less, 12 kDa or less, 10 kDa or less, 9 kDa or less, 8 kDa or less, 7 kDa or less, 6 kDa or less, 5 kDa or less, 4 kDa or less, 3 kDa or less, or 2 kDa or less. In one or more embodiments, the Mn of the polymer is 5 kDa to 100 kDa, 5 kDa to 75 kDa, 5 kDa to 50 kDa, 5 kDa to 40 kDa, 5 kDa to 30 kDa, 5 kDa to 25 kDa, 5 kDa to 20 kDa, or 5 kDa to 10 kDa. In one or more embodiments, the Mn of the polymer is 10 kDa to 100 kDa, 10 kDa to 75 kDa, 10 kDa to 50 kDa, 10 kDa to 40 kDa, 10 kDa to 30 kDa, 10 kDa to 25 kDa, or 10 kDa to 20 kDa. In one or more embodiments, the Mn of the polymer is 20 kDa to 100 kDa, 20 kDa to 75 kDa, 20 kDa to 50 kDa, 20 kDa to 40 kDa, 20 kDa to 30 kDa, or 20 kDa to 25 kDa. In one or more embodiments, the Mn of the polymer is 25 kDa to 100 kDa, 25 kDa to 75 kDa, 25 kDa to 50 kDa, 25 kDa to 40 kDa, or 25 kDa to 30 kDa. In one or more embodiments, the Mn of the polymer is 30 kDa to 100 kDa, 30 kDa to 75 kDa, 30 kDa to 50 kDa, or 30 kDa to 40 kDa. In one or more embodiments, the Mn of the polymer is 40 kDa to 100 kDa, 40 kDa to 75 kDa, or 40 kDa to 50 kDa. In one or more embodiments, the Mn of the polymer is 50 kDa to 100 kDa or 50 kDa to 75 kDa. In one or more embodiments, the Mn of the polymer is 75 kDa to 100 kDa. In one or more embodiments, the Mn of the polymer is 1 kDa to 20 kDa such as 1 kDa to 10 kDa, or 5 kDa to 10 kDa.

The weight-average molecular weight (Mw) of a polymer of the present disclosure may vary. Mw is calculated using the following equation:

$$M w = \sum {w}_{i} {M}_{i}$$

where Mi is the mean molecular size of range i and wi is the weight fraction of the total number of polymer chains that are within Mi range. Mw may be determined using size exclusion chromatography with a multi-angle light scattering detector (see Example).

In one or more embodiments, the Mw of the polymer is 1 kilodalton (kDa) or greater, 2 kDa or greater, 3 kDa or greater, 4 kDa or greater, 5 kDa or greater, 6 kDa or greater, 7 kDa or greater, 8 kDa or greater, 9 kDa or greater, 10 kDa or greater, 12 kDa or greater, 14 kDa or greater, 16 kDa or greater, 18 kDa or greater, 20 kDa or greater, 25 kDa or greater, 30 kDa or greater, 40 kDa or greater, 50 kDa or greater, or 75 kDa or greater. In one or more embodiments, the Mw of the polymer is 100 kDa or less, 75 kDa or less, 50 kDa or less, 40 kDa or less, 30 kDa or less, 25 kDa or less, 20 kDa or less, 18 kDa or less, 16 kDa or less, 14 kDa or less, 12 kDa or less, 10 kDa or less, 9 kDa or less, 8 kDa or less, 7 kDa or less, 6 kDa or less, 5 kDa or less, 4 kDa or less, 3 kDa or less, or 2 kDa or less. In one or more embodiments, the Mw of the polymer is 5 kDa to 100 kDa, 5 kDa to 75 kDa, 5 kDa to 50 kDa, 5 kDa to 40 kDa, 5 kDa to 30 kDa, 5 kDa to 25 kDa, 5 kDa to 20 kDa, or 5 kDa to 10 kDa. In one or more embodiments, the Mw of the polymer is 10 kDa to 100 kDa, 10 kDa to 75 kDa, 10 kDa to 50 kDa, 10 kDa to 40 kDa, 10 kDa to 30 kDa, 10 kDa to 25 kDa, or 10 kDa to 20 kDa. In one or more embodiments, the Mw of the polymer is 20 kDa to 100 kDa, 20 kDa to 75 kDa, 20 kDa to 50 kDa, 20 kDa to 40 kDa, 20 kDa to 30 kDa, or 20 kDa to 25 kDa. In one or more embodiments, the Mw of the polymer is 25 kDa to 100 kDa, 25 kDa to 75 kDa, 25 kDa to 50 kDa, 25 kDa to 40 kDa, or 25 kDa to 30 kDa. In one or more embodiments, the Mw of the polymer is 30 kDa to 100 kDa, 30 kDa to 75 kDa, 30 kDa to 50 kDa, or 30 kDa to 40 kDa. In one or more embodiments, the Mw of the polymer is 40 kDa to 100 kDa, 40 kDa to 75 kDa, or 40 kDa to 50 kDa. In one or more embodiments, the Mw of the polymer is 50 kDa to 100 kDa or 50 kDa to 75 kDa. In one or more embodiments, the Mw of the polymer is 75 kDa to 100 kDa. In one or more embodiments, the Mn of the polymer is 1 kDa to 20 kDa such as 1 kDa to 10 kDa, or 5 kDa to 10 kDa.

The dispersity of the molecular weight of the polymer affect the characteristics of the polymer. The molecular weight dispersity may be quantified as the dispersity (DM). DM is the distribution of individual molecular masses of a polymer. DM is calculated as the quotient of the mass average molecular weight (Mw) divided by the number-average molecular weight (Mn). The Mw and Mn may be determined using various methods including, for example, viscometry, size exclusion chromatography, and mass spectrometry. Generally, a small DM is preferred. Although there is no desired lower limit, in practice the DM of the polymer may be 1.0 or greater, 1.1 or greater, 1.2 or greater, 1.3 or greater, 1.4 or greater, 1.5 or greater, 1.6 or greater, 1.7 or greater, 1.8 or greater, 1.9 or greater, 2.0 or greater, 2.1 or greater, 2.2 or greater, 2.3 or greater. 2.3 or greater, or 2.4 or greater. In some embodiments. In one or more embodiments, the DM of the polymer may be 2.5 or less, 2.2 or less, 2.0 or less, 1.8 or less, 1.7 or less, 1.6 or less, 1.5 or less, 1.4 or less, 1.3 or less, 1.2 or less, or 1.1 or less. In some embodiments. In one or more embodiments, the DM for the polymer is 1.0 to 2.5, 1.0 to 2.2, 1.0 to 2.0, 1.0 to 1.8, 1.0 to 1.7, 1.0 to 1.6, 1.0 to 1.5, 1.0 to 1.4, 1.0 to 1.3, 1.0 to 1.2, or 1.0 to 1.1. In some embodiments. In one or more embodiments, the DM for the polymer is 1.1 to 2.5, 1.1 to 2.2, 1.1 to 2.0, 1.1 to 1.8, 1.1 to 1.7, 1.1 to 1.6, 1.1 to 1.5, 1.1 to 1.4, 1.1 to 1.3, or 1.1 to 1.2. In some embodiments. In one or more embodiments, the DM for the polymer is 1.2 to 2.5, 1.2 to 2.2, 1.2 to 2.0, 1.2 to 1.8, 1.2 to 1.7, 1.2 to 1.6, 1.2 to 1.5, 1.2 to 1.4, or 1.2 to 1.3. In some embodiments. In one or more embodiments, the DM for the polymer is 1.3 to 2.5, 1.3 to 2.2, 1.3 to 2.0, 1.3 to 1.8, 1.3 to 1.7, 1.3 to 1.6, 1.3 to 1.5, or 1.3 to 1.4. In one or more embodiments, the DM for the polymer is 1.4 to 2.5, 1.4 to 2.2, 1.4 to 2.0, 1.4 to 1.8, 1.4 to 1.7, 1.4 to 1.6, or 1.4 to 1.5. In one or more embodiments, the DM for the polymer is 1.5 to 2.5, 1.5 to 2.2, 1.5 to 2.0, 1.5 to 1.8, 1.5 to 1.7, or 1.5 to 1.6. In some embodiments. In one or more embodiments, the DM for the polymer is 1.6 to 2.5, 1.6 to 2.2, 1.6 to 2.0, 1.6 to 1.8, or 1.6 to 1.7. In one or more embodiments, the DM for the polymer is 1.7 to 2.5, 1.7 to 2.2, 1.7 to 2.0, or 1.7 to 1.8. In one or more embodiments, the DM for the polymer is 1.8 to 2.5, 1.8 to 2.2, or 1.8 to 2.0. In one or more embodiments, the DM for the polymer is 2.0 to 2.5, 2.0 to 2.2, or 2.2 to 2.5.

The nanoparticles described herein are at least partially coated with a silica shell. In one or more embodiments, the nanoparticles include a polymer core (e.g., a stimulus-responsive polymer core) and the silica coating. In one or more embodiments, the silica coating may fully encapsulate the polymer core. Alternatively, in one or more embodiments, the silica coating may be discontinuous, thereby providing that at least a part of the surface of the polymer core is exposed.

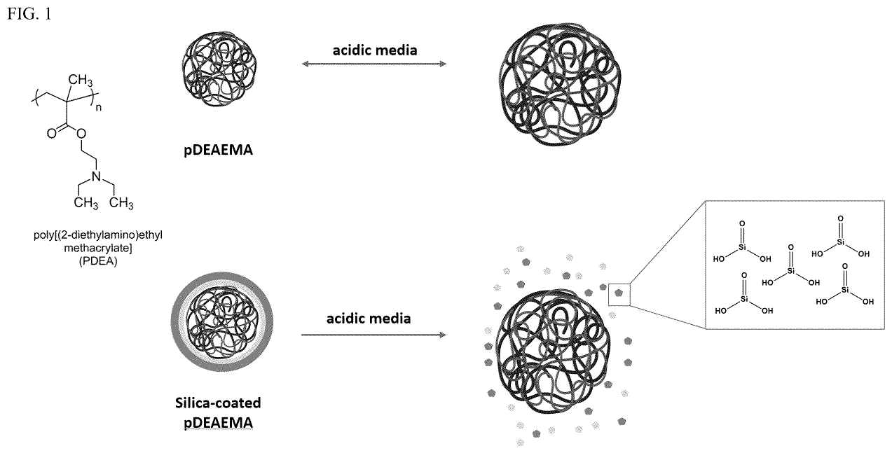

Unlike existing nanoparticle delivery strategies that provide silica within the core of the nanoparticle, the nanoparticles described herein deliver silica from the shell (coating), leaving the core of the nanoparticle available for delivery of additional cargo molecules. As shown in FIG. 1, swelling of the polymer core (in response to a stimulus) causes the silica coating to fracture, generating small silica fragments that cumulatively provide a greater total silica surface area—and, therefore, greater bioavailability—than silica sources having larger size (e.g., a silica-based nanoparticle core).

Greenhouse and field studies have shown that transformations of silica nanoparticles to release silicic acid promote plant growth and suppress disease compared to the use of either commercial silicic acid or bulk silica. The nanoparticles described herein employ a different approach. Rather than employing conventional silica nanoparticle approach that relies on complete dissolution of silica nanoparticles, the nanoparticles described herein employ a hollow silica nanoparticle structures that contains a stimulus-responsive swelling polymer core. This disclosure describes nanoparticles that promote dissolution of silica nanoparticles by generating small, high surface area silica fragments that aid in silicic acid release.

In one or more embodiments, the silica fragments generated by fracture of the silica shell can provide a supply of silicic acid to plants while reducing the likelihood and/or extent to which silica nanomaterials remain in tissues of the target subject after use. Accumulation of silica nanomaterials in tissues of the target subject may be undesirable in, for example, certain biomedical, veterinary, or agricultural applications, especially those in which plants components are intended for livestock and/or human consumption. Thus, the silica-coated nanoparticles described herein may allow one to control silicic acid release after silica nanoparticle transformation, which can be beneficial for agricultural application, and introduces a new design strategy for nano-enabled plant nutrient management. The swelling nature polymer core can enhance silica nanoparticle dissolution by producing silica fragments that, cumulatively, have greater surface area than the same mass of non-fragmented silica nanoparticles, thereby promoting dissolution of silicic acid from the silica fragments.

The silica coating can be described from the viewpoint of the silica precursor (also called a silica coating precursor) or combination of silica precursors used to form the coating. As such, a silica coating formed from a “silica precursor name” can be said to be a “silica precursor name” coating, or silica coating. It is understood that the precursor or combination of silica precursors used to from the coating may undergo a chemical reaction during the formation of the silica coating and, therefore, the chemical species of the silica shell may not have the same chemical composition and/or arrangement of bonds as the precursors.

The silica coating may be prepared using any suitable silica precursor or combination of precursors. Example silica precursors include, but are not limited to, organosilicates, organosilanes, or a combination thereof. Example silica precursors include tetraethyl orthosilicate (TEOS), tetramethyl orthosilicate (TMOS), tetrapropyl orthosilicate, N-[3-(trimethoxysilyl)propy(]ethylenediamine (NPD), 3-aminopropyltriethoxysilane (APTES), 3-aminopropyltrimethoxysilane (APTMS), N-(2-aminoethyl)-3-aminopropyltriethoxysilane (AEAPTES), N-(2-aminoethyl)-3-aminopropyltrimethoxysilane (AEAPTMS), N-(6-aminohexyl) aminomethyltriethoxysilane (AHAMTES), 3-aminopropyldimethylethoxysilane (APDMES), 3-mercaptopropyltrimethoxysilane (MPTMS), glycidyloxypropyl-trimethoxysilane (GOPS), 3-(trimethoxysilyl)propyl methacrylate, 3-(triethoxysilyl)propyl methacrylate, or any combination thereof.

In one or more embodiments, the nanoparticle includes a second coating. In one or more embodiments, the nanoparticle includes a second coating disposed between the silica coating and the polymer core. The second coating can be continuous or discontinuous. In one or more embodiments, at least a portion of the second coating is in direct contact with the polymer core and at least a portion of the silica coating is in direct contact with at least a portion of the second coating. In embodiments where the second coating is discontinuous, the silica coating may be disposed on both the second coating and the polymer core. The second coating may facilitate the formation of the silica coating. For example, the second coating may facilitate silica condensation on the surface of the polymer core.

The second coating can be described from the viewpoint of the second coating precursor or combination of precursors used to form the second coating. As such, a second coating formed from a “second coating precursor name” can be said to be a “second coating precursor name” second coating. It is understood that the second coating precursor or combination of precursors used to from the second coating may undergo a chemical reaction during the formation of the second coating and, therefore, the chemical species of the second coating may not have the same chemical composition and/or arrangement of bonds as the second coating precursor.

The second coating can be formed from any suitable precursor. The second coating precursor may be a bifunctional silane compound. The second coating precursor can react with the polymer core and/or a plurality of second coating precursor compounds can react with each other to form a polymer. In one or more embodiments, the second coating precursor includes an acrylate or methacrylate moiety and an —Si—(OR)₃ (where each R is independently alkyl) moiety. The —Si—(OR)₃ portion of the compound can function as a second silica precursor that can react with the silica precursor used to form the silica layer. Example second coating precursor compounds include, but are not limited to 3-methacryloxypropyltrimethoxysilane, 3-(methacryloyloxy)propyltris(trimethylsiloxy), 3-methacryloxypropyl tris-2-propoxy silane, 3-methacryloxypropylmethyldimethoxysilane, 3-(trimethoxysilyl)propyl methacrylate, and 3-(acryloyloxy)propyltrimethoxysilane.

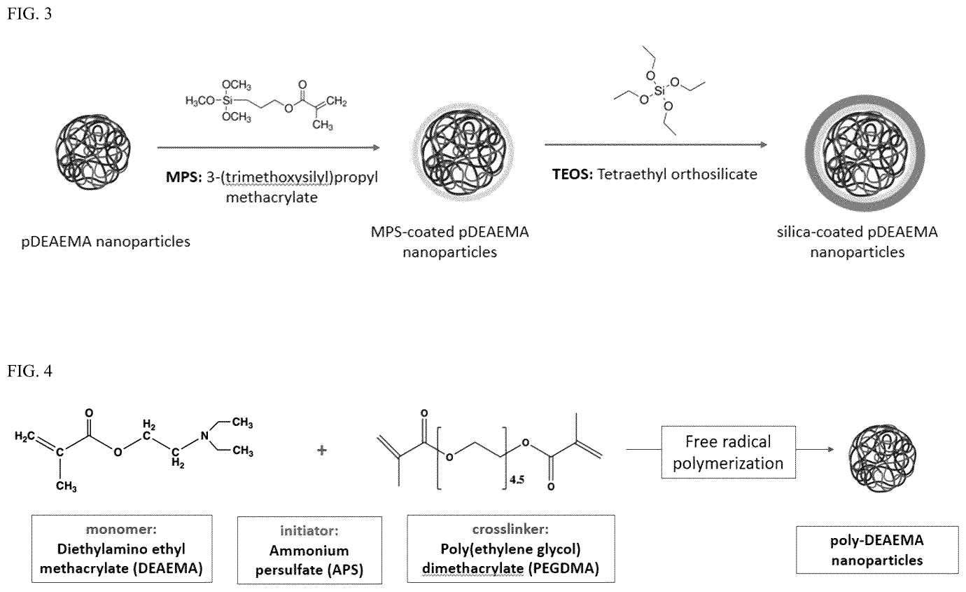

FIG. 3 shows an example schematic for forming nanoparticles having an MPS coating (second coating) and a silica coating. First, poly(diethylamino ethyl methacrylate) (pDEAEMA) nanoparticles can be synthesized by free radical polymerization of 2-diethylaminoethylmethacrylate (DEAEMA) monomers in the presence of an initiator (e.g., ammonium persulfate) and a crosslinker (poly(ethylene glycol) dimethacrylate (PEGDMA)). Once formed, the pDEAEMA nanoparticles can be coated with a second coating before applying the silica coating. The second coating can be applied by exposing the nanoparticle (e.g., pDEAEMA nanoparticle) to a second coating precursor, for example, MPS. Following application of the second coating, the silica coating can be applied by exposing the second coating coated nanoparticles (e.g., MPS-coated pDEAEMA nanoparticles) to a silica coating precursor such as TEOS to form the silica coated pDEAEMA nanoparticles.

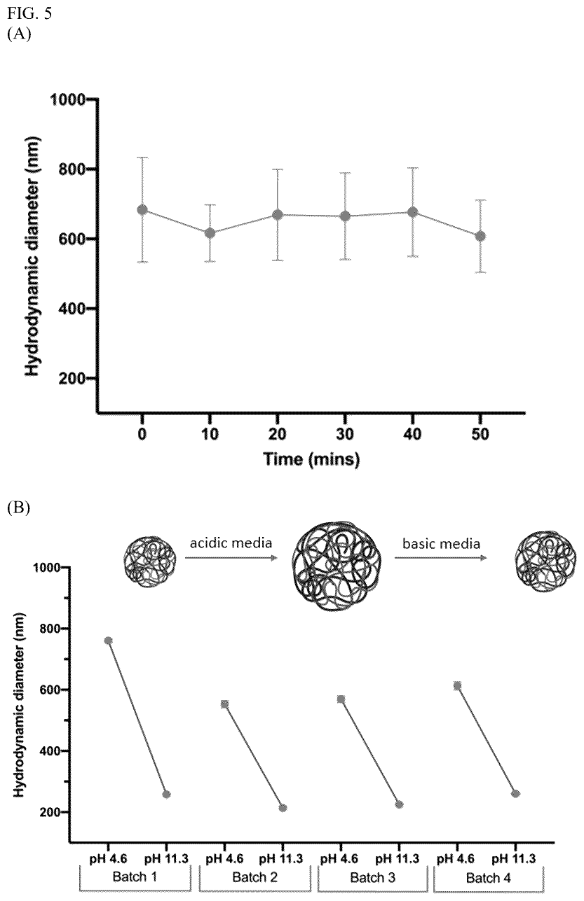

The swelling behavior of pDEAEMA nanoparticles was explored at different pH values. Various batches of pDEAEMA were sequentially exposed to acidic conditions (pH 4.6 potassium phosphate buffer) then basic conditions (ammonium hydroxide solution at pH 11.3). FIG. 5 (B) shows that the hydrodynamic diameter of various batches of pDEAEMA nanoparticles was larger when the nanoparticles were exposed to acidic conditions compared to basic conditions. The nanoparticles swelled in acid conditions and contracted in when transferred to basic conditions indicating the reversibility of the swelling behavior. FIG. 5 (A) indicates that swelling of a pDEAEMA in acid conditions is instantaneous and is maintained over time in acid conditions.

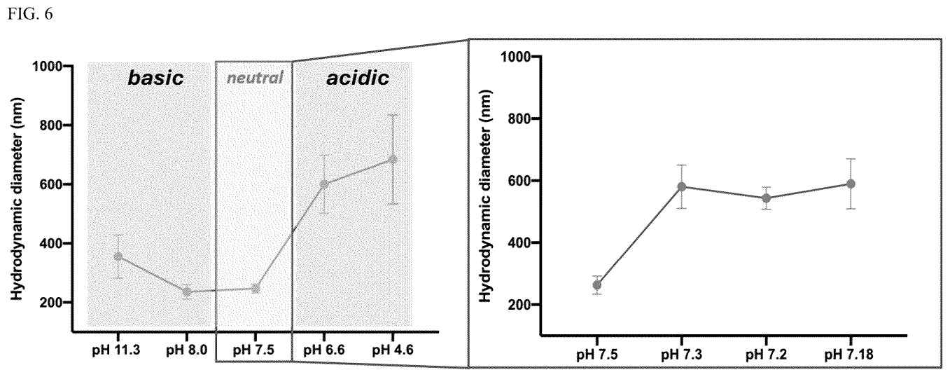

pDEAEMA nanoparticles were exposed to pH values between 4.6 to 11.3 to more closely evaluate their swelling behavior under different conditions. pDEAEMA nanoparticles swell when exposed to pH values near or lower than the pKb of pDEAEMA (pKb of pDEAEMA is 7.0 to 7.3; FIG. 6; data acquired in potassium phosphate buffers).

The biocompatibility of pDEAEMA nanoparticles (without a silica coating) was evaluated by exposing tomato plants to various amounts of the pDEAEMA nanoparticles (see the Tomato Plant Greenhouse Study in the Examples). There was no significant difference in shoot weight observed between the pDEAEMA treatment groups and the control treatment groups (phosphate buffered saline treatment (PBS) and deionized water (DI) treatment) (FIG. 8).

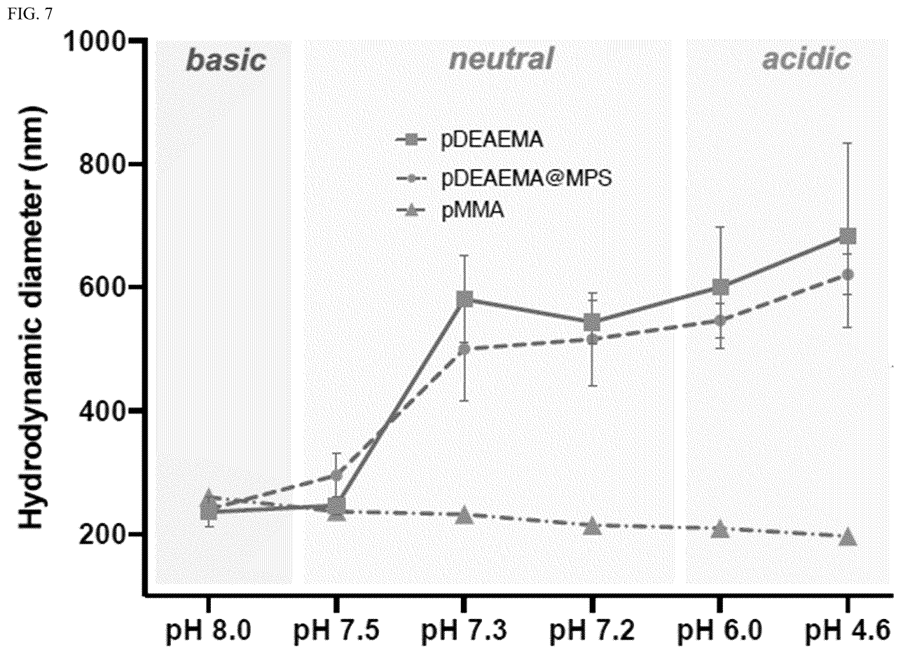

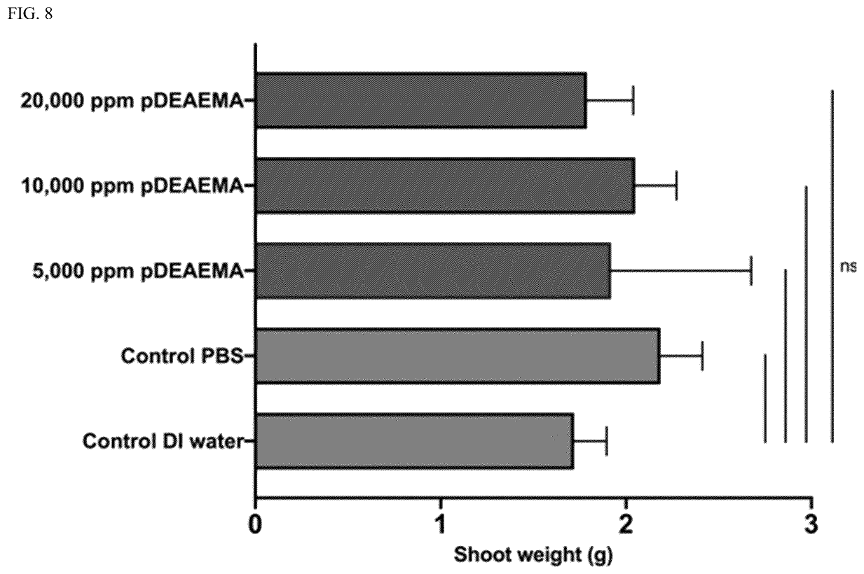

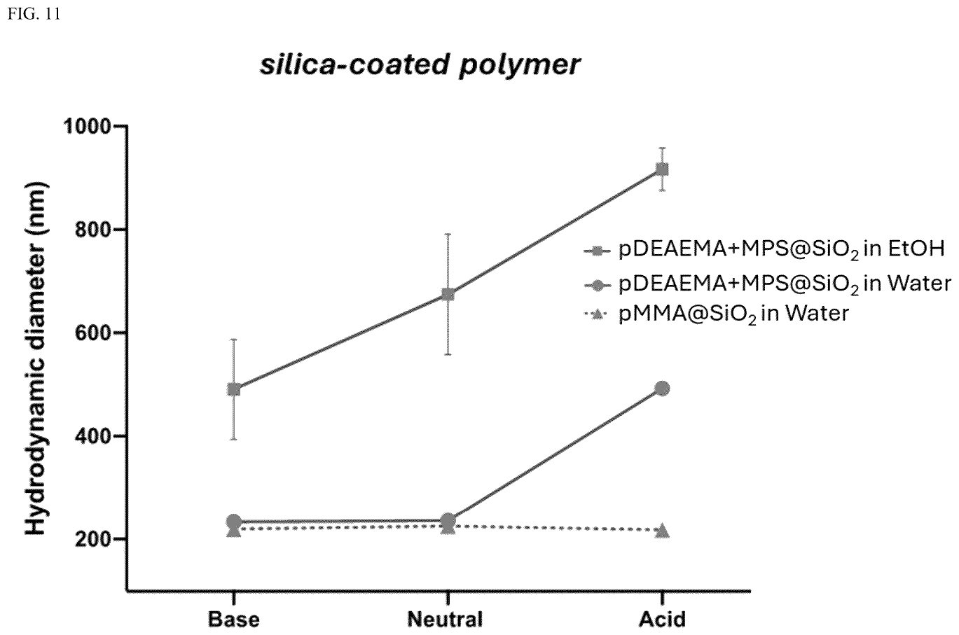

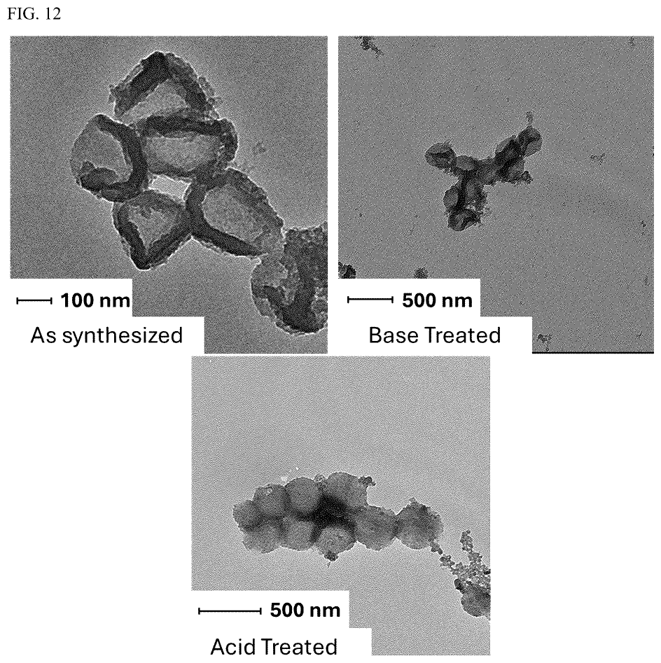

The swelling behavior of nanoparticles having a second coating and lacking a second coating was compared. Nanoparticles having a pDEAEMA core and no second coating as well as nanoparticles having a pDEAEMA core and second coating formed from MPS were synthesized (see Examples). A non-swelling polymer (poly(methyl methacrylate), pMMA) was also synthesized. With no silica coating, the pDEAEMA only particles and pDEAMA+MPS particles exhibited similar swelling behavior when exposed to different pH values (FIG. 7). After addition of a silica coating formed from TEOS to the pDEAMA+MPS, the nanoparticle continued to display swelling behavior when exposed to various pH values (FIG. 11). An elemental map of the silica coated pDEAEMA+MPS nanoparticles indicated a carbon-rich polymer core (red) and a silica shell (blue) partially coating the polymer core (FIG. 10).

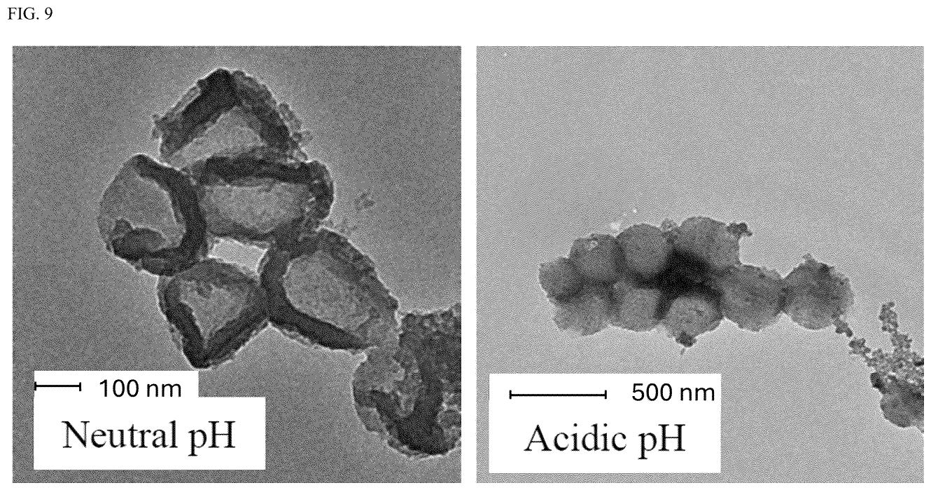

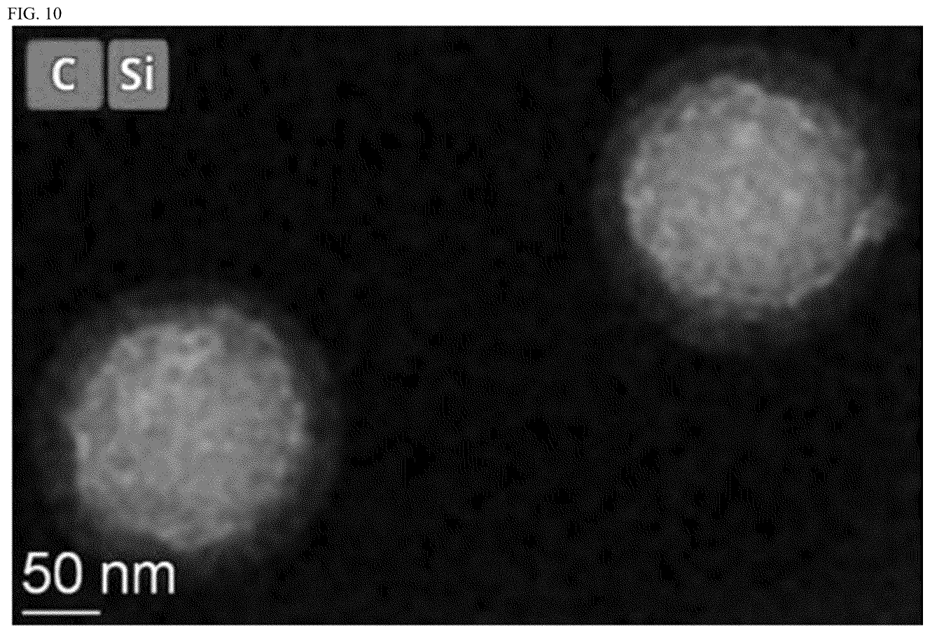

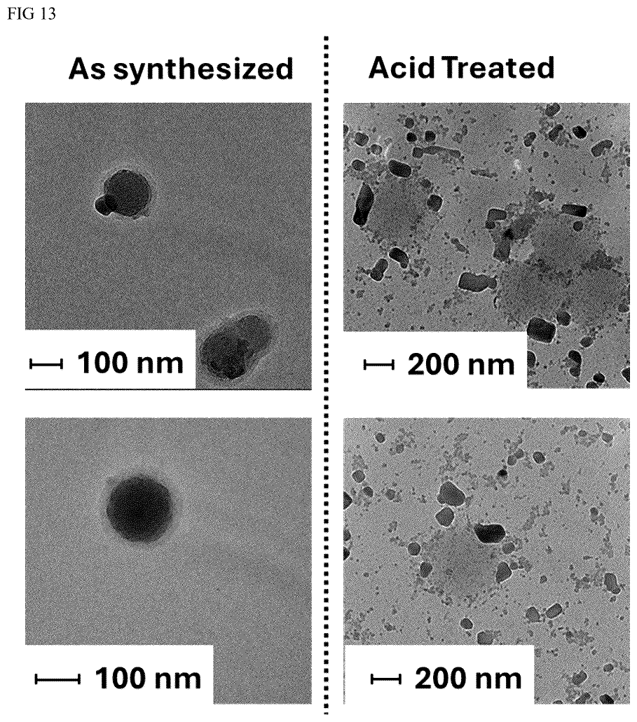

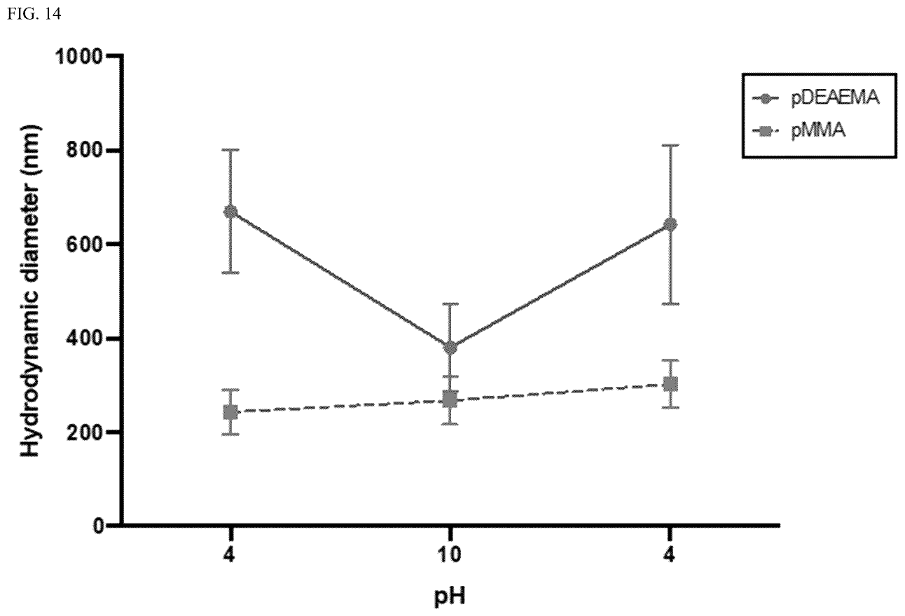

The swelling behavior of pDEAEMA nanoparticles coated with silica (see Examples for synthesis) was explored. At a neutral pH, the silica coated pDEAEMA nanoparticles showed a varied mass contrast in the transmission electron microscopy (TEM) images (FIG. 9, neutral pH; and FIG. 12, as synthesized). When the silica coated pDEAEMA nanoparticles were exposed to acidic conditions the mass contrast disappeared (FIGS. 9 and 12), indicating at least partial removal of the silica shell (silica coating). Additionally, a clear change in size of the particles is seen from the synthesized to the acid treated particles (see FIGS. 9, 12, and 13). However, when the silica coated pDEAEMA nanoparticles were exposed to basic conditions, the mass contrast was still present. As such, the change in mass contrast is an acid treatment specific transformation.

In one or more embodiments, the nanoparticles may be loaded with one or more species of cargo molecules to be delivered to a target subject. The cargo may be loaded into the polymer core, the silica shell, or both. For example, the cargo may be a detectable marker for diagnostic or tracking applications. As another example, the cargo may be a peptide, an oligonucleotide, a nutrient, a pesticide, etc., or a combination of two or more cargo molecule species. Exemplary cargo therefore includes, but is not limited to, genetic material (e.g., DNA or RNA) that encodes for one or more polypeptides whose expression by a recipient subject organism is desired; genetic material (e.g., DNA or RNA) that interferes with expression of one or more genes or polypeptides whose expression is undesirable, regardless of whether the target of the inhibition is native to the recipient subject organism or an infectious agent (e.g., bacterium, virus, or parasite) that may infect the recipient subject organism; a small molecule such as, for example, a dye (e.g., rhodamine isothiocyanate, RITC) or an essential oil (e.g., peppermint, thymol, lavender and tea tree oil, etc.); a detectable label (e.g., a colorimetric label, a radiolabel, a fluorescent label, etc.); a fertilizer such as, for example, a copper salt (e.g., Cu₂NO₃) or a nitrogen-phosphorus-potassium (NPK) fertilizer; an immunostimulant such as, for example, chitin; or any combination of two or more cargo molecule species.

Thus, in one or more embodiments, the polymer core may be loaded with one or more species of cargo molecules. Such embodiments allow for a dual release platform in which silicic acid is released from the silica shell and one or more cargo molecules are released from the polymer core.

The polymer cores may therefore be loaded with bioactive cargo. The polymer core may be loaded with cargo by any suitable physical or chemical method. For example, in one or more embodiments, cargo molecules may be loaded into the polymer core by adjusting the physical or chemical parameters to which the polymer responds (e.g., pH or redox potential) to swell the polymers while incubating the polymer with the cargo, then reversing the physical or chemical conditions to facilitate deswelling of the polymer core, thereby sequestering the cargo within the core for future release. Alternatively, the core may be loaded with one or more species of cargo molecules by passive loading, through electrostatic interactions, through hydrogen bonding, or by introducing binding sites for particular cargo (e.g., aptamers, imprinted polymers, antibody fragments, antibodies, etc.). Regardless of the manner in which the core is loaded with cargo, the cargo-loaded polymer core can then be subsequently coated with silica.

The polymer core may be designed to possess a desired average diameter to exploit, for example, size-based loading differences, size-based differences in the uptake of nanoparticles by a target organism (e.g., a plant), and/or size-based release of cargo molecules.

In one or more embodiments, the cargo may be loaded into or onto the silica shell. For embodiments in which cargo molecules are loaded into or integrated into the silica shell, the silica shell may be loaded by adding the cargo molecule during the silica condensation reaction so that the cargo molecule is physically entrapped in the network covalent silica structure. Alternatively, cargo molecules may be loaded onto or into the silica shell by incubating the silica-coated nanoparticle in a solution containing the cargo molecules and exploiting electrostatic interaction between the silica shell and the cargo molecules. In such embodiments, release of the cargo molecules can be controlled upon fragmentation of the silica shell in the same way that release of silicic acid from the silica fragments is controlled.

In one or more embodiments, cargo molecules may be loaded onto the surface of the silica shell via surface modifications. The silica shell can include one or more surface modification to facilitate attachment of one or more active agents (e.g., cargo molecules), modify one or more physical or chemical characteristics of the silica shell, and/or modify the functionality, surface charge, and/or transformation of the silica shell. Exemplary surface modification include, but are not limited to, PEG-silane and tetramethyl silane (TMS).

The average hydrodynamic size of the nanoparticle prior to exposure to a stimulus may vary. The average hydrodynamic size can be measured, for example, using dynamic light scattering (see the Examples). In one or more embodiments, the average hydrodynamic size of a plurality of nanoparticles prior to exposure to a stimulus may be 50 nm or greater, 75 nm or greater, 100 nm or greater, 125 nm or greater, 150 nm or greater, 175 nm or greater, 200 nm or greater, 225 nm or greater, 250 nm or greater, or 275 nm or greater. In one or more embodiments, the average hydrodynamic size of a plurality of nanoparticles prior to exposure to a stimulus may be 300 nm or less, 275 nm or less, 250 nm or less, 225 nm or less, 200 nm or less, 175 nm or less, 150 nm or less, 125 nm or less, 100 nm or less, or 75 nm or less.

The average hydrodynamic size of the nanoparticle during and/or after exposure to a stimulus may vary. In one or more embodiments, the average hydrodynamic size of a plurality of nanoparticles during and/or after exposure to a stimulus may be 350 nm or greater, 375 nm or greater, 400 nm or greater, 425 nm or greater, 450 nm or greater, 475 nm or greater, 500 nm or greater, 525 nm or greater, 550 nm or greater, 575 nm or greater 600 nm or greater, 625 nm or greater, 650 nm or greater, 675 nm or greater, 700 nm or greater, 725 nm or greater, 750 nm or greater, 775 nm or greater, 800 nm or greater, 825 nm or greater, 850 nm or greater, 875 nm or greater, 900 nm or greater, 925 nm or greater, 950 nm or greater, or 975 nm or greater. In one or more embodiments, the average hydrodynamic size of a plurality of nanoparticles during and/or after exposure to a stimulus may be 1000 nm or less, 975 nm or less, 950 nm or less, 925 nm or less, 900 nm or less, 875 nm or less, 850 nm or less, 825 nm or less, 800 nm or less, 775 nm or less, 750 nm or less, 725 nm or less, 700 nm or less, 675 nm or less, 650 nm or less, 625 nm or less, 600 nm or less, 575 nm or less, 550 nm or less, 525 nm or less, 500 nm or less, 475 nm or less, 450 nm or less, 425 nm or less, 400 nm or less, or 375 nm or less.

Upon exposure to the stimulus, the hydrodynamic diameter of the nanoparticle may increase. In one or more embodiments, the average hydrodynamic diameter of a plurality of nanoparticles during and/or after exposure to the stimulus is 2 times or greater, 2.5 times or greater, 3 times or greater, 3.5 times or greater, 4 times or greater, 4.5 times or greater, 5 times or greater, 5.5 times or greater, 6 times or greater, 6.5 times or greater, 7 times or greater, 7.5 times or greater, 8 times or greater, 8.5 times or greater 9 times or greater, or 9.5 times or greater than the hydrodynamic diameter of the plurality of nanoparticles prior to exposure to the stimulus.

In another aspect, the present disclosure describes a method of making the nanoparticles of the present disclosure. The method includes forming a polymeric core. The polymeric core includes the stimulus-responsive polymer. In one or more embodiments, forming the polymeric core includes polymerizing the stimulus-responsive polymer from one or more monomers. The polymerization reaction may include the use of initiators (e.g., ammonium persulfate), catalysts, solvents, capping groups, crosslinking groups, and the like. Crosslinkers may be added, for example, at the beginning of the polymerization reaction. The polymer may be formed, for example, using free radical polymerization of one or more monomers in the presence of an initiator.

In embodiments where the nanoparticle includes a second coating disposed between the polymer core and the silica coating, the method may further include coating at least a portion of the polymer core with the second coating. In one or more embodiments, coating at least a portion of the polymer core with the second coating may include incubating a second coating mixture that includes a solvent, the polymer core, and a second coating precursor. The solvent can be any suitable solvent. In one or more embodiments, the solvent includes or is water. The second coating precursor can be any suitable second coating precursor such as those disclosed herein. In one or more embodiments, the second coating mixture includes a catalyst. The catalyst may facilitate the hydrolysis and condensation of the siloxane bonds and/or the formation of a covalent bond between the polymer core and the reactive handle of the second coating precursor. An example catalyst includes NH₄OH. In one or more embodiments, the silica precursor can be added slowly (e.g., dropwise) to the coating mixture. In one or more embodiments during incubation of the second coating mixture, the second coating mixture may be agitated. In one or more embodiments during incubation of the second coating mixture, the coating mixture may be exposed to an elevated temperature (e.g., 50 degrees Celsius).

The method further includes coating at least a portion of the polymer core (or polymer core coated with the second coating) with a silica coating. In some such embodiments, the method includes incubating a coating mixture that includes a solvent, the polymer core (or polymer core coated with the second coating), and a silica coating precursor. The solvent can be any suitable solvent. In one or more embodiments, the solvent includes or is water. The silica coating precursor can be any suitable silica coating precursor such as those disclosed herein. In one or more embodiments, the coating mixture includes a catalyst. The catalyst may facilitate the hydrolysis and condensation of the siloxane bonds. An example catalyst includes NH₄OH. In one or more embodiments, the silica precursor can be added slowly (e.g., dropwise) to the coating mixture. In one or more embodiments during incubation of the coating mixture, the coating mixture may be agitated. In one or more embodiments during incubation of the coating mixture, the coating mixture may be exposed to an elevated temperature (e.g., 50 degrees Celsius).

In some embodiments, the nanoparticles described herein may be designed for agricultural applications including, but not limited to, triggered delivery of cargo to target subject plants, triggered delivery of silicic acid within tissues of target plants, controlling silica nanoparticle transformation, providing a sustained, source of silicic acid to target subject plants, etc.

For example, the silica-coated nanoparticles described herein can promote plant growth and/or provide resistance to disease. Small, high-surface area silica fragments that result from the swelling of the stimulus-responsive polymer core can serve as a source of silicic acid for plants. The stimulus-responsiveness of the polymer core can permit triggered release within plants of cargo molecules (e.g., pesticides, siRNA, etc.) along with the silicic acid released from the silica fragments. The nanoparticles described herein can therefore provide silicic acid and cargo to fight crop-compromising diseases and enhance crop yield.

In this application, the nanoparticles may be used as an alternative to soil fumigants. Currently, a common method to control a variety of soil-borne pests and pathogens is soil fumigation. However, soil fumigants can be damaging to the environment and soil microbiome, which has now led to the search for soil fumigants substitutes in agriculture. The silica coating of the nanoparticles described herein can dissolve and release beneficial silicic acid at differing rates to serve as alternatives to soil fumigants. For example, the silica-coated nanoparticles may be designed to use tetraethyl orthosilicate (TEOS) as a silica precursor to produce nanoparticles having a slow-dissolving silica coating. In contrast, nanoparticles having a fast-dissolving silica coating can be produced using (3-aminopropyl) triethoxysilane (APTES) as a precursor, with the optional addition of TEOS. The nanoparticle system described herein therefore allow for controlled silicic acid release profile.

While described herein in the context of exemplary embodiments in which silica-coated nanoparticles are designed and prepared for agricultural applications, the silica-coated swelling polymeric nanoparticles described herein may be engineered for alternative applications. For example, the stimulus-responsive, silica-coated swelling polymer nanoparticle could be useful in any application where molecular cargo delivery is relevant (e.g., biomedical applications).

In another aspect, the present disclosure describes compositions that include the nanoparticles of the present disclosure. A composition includes nanoparticles of the present disclosure and a carrier. The formulations of the composition may include those suitable for treating the soil in which the target plant grows or the target plant directly. Types of formulations may include baits, gels, dusts, water dispersible granules, dry powders, soluble powders, dry granules, pellets, emulsions, solutions, suspensions, impregnated products, fertilizer combinations, or aerosols.

The carrier may be any suitable carrier. In one or more embodiments, the carrier is a liquid, for example water. For example, nanoparticles may be included in a water mixture or suspension. The carrier may be a solid. For example, the carrier may include soil. The composition may include other ingredients. For example, the composition may include fertilizer, plant nutrients, pesticides, compatibility agents, activating agents, buffers, anti-foaming agents, spray colorants, drift control agents, water conditioners, surfactants, or any combination thereof.

In another aspect, the present disclosure describes a method of administering a nanoparticle or composition of the present disclosure to a subject. The subject (or “target subject”) may be any organism to which the nanoparticles of the present disclosure are to be administered. Thus, for example, the target subject for administration of nanoparticles designed for agricultural use may be a plant. As another example, the target subject for administration of nanoparticles designed for a biomedical or veterinary use may be an animal, including a human.

Exemplary plants that may be a target subject include, but are not limited to, a field crop (e.g., tobacco, soybeans, corn, cotton, fruits, rice, wheat, vegetables, legumes, nuts, potatoes, watermelon etc.), a tree (e.g., poplar, rubber tree, etc.), or turfgrass (e.g. creeping bentgrass).

Exemplary animals that may be a target subject include, but are not limited to, a human or a non-human animal such as, for example, a livestock animal, a laboratory animal, or a companion animal. Exemplary non-human animal subjects include, but are not limited to, animals that are hominid (including, for example chimpanzees, gorillas, or orangutans), bovine (including, for instance, cattle), caprine (including, for instance, goats), ovine (including, for instance, sheep), porcine (including, for instance, swine), equine (including, for instance, horses), members of the family Cervidae (including, for instance, deer, elk, moose, caribou, or reindeer), members of the family Bison (including, for instance, bison), feline (including, for example, domesticated cats, tigers, lions, etc.), canine (including, for example, domesticated dogs, wolves, etc.), avian (including, for example, turkeys, chickens, ducks, geese, etc.), a rodent (including, for example, mice, rats, etc.), a member of the family Leporidae (including, for example, rabbits or hares), members of the family Mustelidae (including, for example ferrets), or member of the order Chiroptera (including, for example, bats). In one or more embodiments, the method includes delivering nanoparticles or composition including the same to a target subject. For example, the method may include delivering nanoparticles or compositions include the same to a target plant, the seeds of a target plant, or the soil a target plant grows in. The type of delivery may depend at least in part on the formulation of the composition that includes the nanoparticles. For example, in one or more embodiments, the composition including the nanoparticles that is liquid can be delivered to the subject by spraying or misting the plant, the seed or a plant, or the soil the plant grows in. In other embodiments, the composition including the nanoparticles that is solid can be placed in contact with a plant, a seed of a plant, or a soil the plant grows in.

In another aspect, the present disclosure describes a method of delivering silicic acid to a target subject. The method includes administering the nanoparticles or composition containing the same to a target subject, a media in contact with the target subject, or both. An example media in contact with a target subject can be the soil in which the plant or seed is located. Administering the nanoparticles or compositions containing the same may include contacting a target subject, a target subject seed, or the soil in which a target subject grows with the nanoparticles or composition containing the nanoparticles.

In one or more embodiments, the target subject or a media in contact with the target subject (e.g., soil) includes a stimulus to which the stimulus-responsive polymer. The stimulus-responsive polymer may respond at the time of administration. For example, the soil in which a target plant or seeds of a target plant grows may be acid or basic. The method may further include allowing the target subject's stimulus or the stimulus in the media in contact with the target subject to stimulate (or interact with) the nanoparticles thereby causing the polymer core to swell and fracture the silica shell into fragment. The method can further include allowing silicic acid to be released from the fragments.

In one or more embodiments, the target subject or a media in contact with the target subject (e.g., soil) does not include a stimulus to which the stimulus-responsive polymer responds at the time of administration. In one or more embodiments, the method includes providing a stimulus to which the stimulus-responsive polymer responds. For example, the target subject, the media in contact with the target subject, or both can be treated with an acid solution, a basic solution, a solution having a redox potential that can stimulate the polymer, or any combination thereof. A change in light (e.g., a change in light intensity and/or wavelength of light) can be applied to the target subject, the media in contact with the target subject, or both. The target subject, the media in contact with the target subject, or both can be exposed to a change in temperature. The method further includes allowing the stimulus to stimulate (or interact with) the nanoparticles thereby causing the polymer core to swell, fracturing the silica coating into fragments. The method further includes allowing silicic acid to release from the fragments.

Below there is provided a non-exhaustive listing of non-limiting exemplary embodiments. Any one or more of the features of these embodiments may be combined with any one or more features of another example, embodiment, or aspect described herein.

Exemplary Embodiments (abbreviated in the following list as “E #”)
E1. A nanoparticle comprising: a stimulus-responsive polymer core; and a silica coating disposed on at least a portion of the polymer core.
E2. The nanoparticle of E1, wherein the stimulus-responsive polymer swells in response to a stimulus.
E3. The nanoparticle of E1 or E2, wherein the stimulus-responsive polymer core comprises a pH-responsive polymer.
E4. The nanoparticle of any of E1 to E3, wherein the stimulus-responsive polymer has a pKa of 2 to 8.
E5. The nanoparticle of any of E1 to E3, wherein the stimulus-responsive polymer has a pKb of 5 to 14.
E6. The nanoparticle of any of E1 to E5, wherein the stimulus-responsive polymer comprises acidic moieties.
E7. The nanoparticle of any of E1 to E6, wherein the acidic polymer comprises poly(acrylic acid), poly(methacrylic acid), poly(ethacrylic acid), or any combination thereof.
E8. The nanoparticle of any of E1 to E5, wherein the stimulus-responsive polymer comprises basic moieties.
E9. The nanoparticle of any of E1 to E5 or E8, wherein the stimulus-polymer comprises poly(2-dimethylamino)ethyl methacrylate, poly(2-dipropylamino)ethyl methacrylate, poly(2-diisopropylamino)ethyl methacrylate, poly(2-dimethylamino)ethyl acrylate, or any combination thereof.
E10. The nanoparticle of E1 or E2, wherein the stimulus-responsive polymer core comprises a redox-responsive polymer.
E11. The nanoparticle of any of E1, E2, or E10, wherein the stimulus-responsive polymer core comprises polyphenylene sulfide.
E12. The nanoparticle of E1 or E2, wherein the stimulus-responsive polymer core comprises a light-responsive polymer.
E13. The nanoparticle of E1, E2, or E12, wherein the stimulus-responsive polymer core comprises poly(N-isopropylacrylamide) (pNIPAAm) copolymers comprising pendant benzophenone units.
E14. The nanoparticle of E1 or E2, wherein the stimulus-responsive polymer core comprises a temperature-responsive polymer.
E15. The nanoparticle of E1, E2, or E14, wherein the stimulus-responsive polymer core comprises poly(N-isopropylacrylamide); poly[2-(dimethylamino)ethyl methacrylate](pDMAEMA); hydroxypropylcellulose; poly(vinylcaprolactam); poly-2-isopropyl-2-oxazoline; polyvinyl methyl ether, or any combination thereof.
E16. The nanoparticle of any of E1 to E15, wherein the stimulus-responsive polymer has a number average molecular weight of 1 kDa to 10 kDa.
E17. The nanoparticle of any of E1 to E16, wherein the hydrodynamic diameter of an uncoated stimulus-responsive polymer core or the hydrodynamic diameter of a plurality of uncoated stimulus-responsive polymer cores after exposure to a stimulus is at least 2 times greater than the hydrodynamic diameter of the uncoated stimulus-responsive polymer core or the hydrodynamic diameter of the plurality of uncoated stimulus-responsive polymer cores prior to exposure to the stimulus.
E18. The nanoparticle of anyone of E1 to E17, comprising at least one species of cargo molecule loaded into or onto the nanoparticle.
E19. The nanoparticle of E18, wherein the cargo molecule is loaded into the core.
E20. The nanoparticle of E18, wherein the cargo molecule is incorporated into the silica shell.
E21. The nanoparticle of any of E18-E20, wherein the cargo molecule is attached to the surface of the silica shell.
E22. The nanoparticle of any of E18-E21, wherein the cargo molecules comprises a detectable marker, genetic material, fertilizer, an immunostimulant, or any combination thereof.
E23. The nanoparticle of E1 to E22, wherein the nanoparticle further comprises a second coating disposed on a least a portion of the stimulus-responsive polymer core, wherein the silica coating is disposed on at least a portion of the second coating, at least a portion of the stimulus-responsive polymer core, or both.
E24. The nanoparticle of E23, wherein the second coating is formed from at least a second coating precursor, the second coating precursor comprising 3-methacryloxypropyltrimethoxysilane, 3-(methacryloyloxy)propyltris(trimethylsiloxy), 3-methacryloxypropyl tris-2-propoxy silane, 3-methacryloxypropylmethyldimethoxysilane, 3-(trimethoxysilyl)propyl methacrylate, and 3-(acryloyloxy)propyltrimethoxysilane.
E25. The nanoparticle of any of E1 to E24, wherein the silica coating comprises a surface modification.
E26. A method of preparing the nanoparticle of any of Embodiments 1 to 25, the method comprising: preparing (or forming) a polymer core comprising a stimulus-responsive polymer; and coating at least a portion of the core with a silica coating.
E27. The method of E26, further comprising coating at least a portion of the polymer core with a second coating. The second coating can be, for example, formed from a second coating precursor such as those in Embodiment 24.
E28. The method of E26 or E27, further comprising modifying at least a portion of the silica coating, thereby creating a surface modification.
E29. The method of any of E26-E28, further comprising loading the core with at least one species of cargo molecule.
E30. The method of any of E26 to E29, further comprising loading the silica coating with at least one species of cargo molecule.
E31. The method of E28, further comprising attaching at least one species of cargo molecule to the silica coating via the surface modification.
E32. A method of delivering silicic acid to a target subject, the method comprising: preparing the nanoparticle of any one of E1-E25, wherein the target subject comprises a stimulus to which the stimulus-responsive polymer responds; administering the nanoparticle to the target subject; allowing the target subject's stimulus to react with the nanoparticle, thereby causing the polymer core to swell, fracturing the silica shell into fragments comprising silicic acid; and allowing silicic acid to release from the fragments.
E33. The method of E32, wherein the stimulus is pH, redox potential, temperature, or light.
E34. A method of delivering silicic acid to a target subject, the method comprising: preparing the nanoparticle of any one of E1-E25, wherein the target subject does not comprise a stimulus to which the stimulus-responsive polymer responds; administering the nanoparticle to the target subject; providing a stimulus to which the stimulus-responsive polymer responds; allowing the stimulus to react with the nanoparticle, thereby causing the polymer core to swell, fracturing the silica shell into fragments comprising silicic acid; and allowing silicic acid to release from the fragments.
E25. The method of E34, wherein the stimulus is pH, redox potential, temperature, or light.

In the preceding description and following claims, the term “and/or” means one or all of the listed elements or a combination of any two or more of the listed elements; the terms “comprises,” “comprising,” and variations thereof are to be construed as open ended i.e., additional elements or steps are optional and may or may not be present; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

In the preceding description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

As used herein, “have,” “has,” “having,” “include,” “includes,” “including,” “comprise,” “comprises,” “comprising” or the like are used in their open-ended inclusive sense, and generally mean “include, but not limited to,” “includes, but not limited to,” or “including, but not limited to.” Further, wherever embodiments are described herein with the language “have,” “has,” “having,” “include,” “includes,” “including,” “comprise,” “comprises,” “comprising” and the like, otherwise analogous embodiments described in terms of “consisting of” and/or “consisting essentially of” are also provided. The term “consisting of” means including, and limited to, that which follows the phrase “consisting of.” That is, “consisting of” indicates that the listed elements are required or mandatory, and that no other elements may be present. The term “consisting essentially of” indicates that any elements listed after the phrase are included, and that other elements than those listed may be included provided that those elements do not interfere with or contribute to the activity or action specified in the disclosure for the listed elements.

In several places throughout the above description, guidance is provided through lists of examples, which examples can be used in various combinations. In each instance, the recited list serves only as a representative group and should not be interpreted as an exclusive list.

For any method disclosed herein that includes discrete steps, the steps may be performed in any feasible order. And, as appropriate, any combination of two or more steps may be performed simultaneously.

As used herein, the word “exemplary” means to serve as an illustrative example and should not be construed as preferred or advantageous over other embodiments.

As used herein, the terms “preferred” and “preferably” refer to embodiments of the invention that may afford certain benefits under certain circumstances. However, other embodiments may also be preferred under the same or other circumstances. Furthermore, the recitation of one or more preferred embodiments does not imply that other embodiments are not useful and is not intended to exclude other embodiments from the scope of the invention.

The term “polymer” and “polymeric material” include, but are not limited to homopolymers, copolymers, blends of two or more homopolymers, blends of two or more copolymers, blends of one or more homopolymers and one or more copolymers that have any geometric configuration such as a linear configuration, branched configuration, graft configuration, star configuration, isotactic symmetry, syndiotactic symmetry, atactic symmetry, or any combination thereof. Copolymers are polymers polymerized from two or more monomers and include block copolymers, alternating copolymers, periodic copolymers, statistical copolymers, stereoblock copolymers, gradient copolymers, and the like. Polymers are polymerized from one or more monomers. A polymer polymerized from a particular monomer may be described as “monomer name” polymer or poly(monomer name). For example, a polymer polymerized from n-butyl acrylate monomers, may be described as an n-butyl acrylate polymer or poly(n-butyl acrylate).

As used herein, the terms “formed from” and “polymerized from” are open ended and may include other components that may not be expressly described relative to the subject that is formed from or polymerized from the stated components. For example, a polymer formed from or polymerized from one or more monomers may include capping groups or other groups not expressly mentioned.

### EXAMPLES

The present invention is illustrated by the following examples. It is to be understood that the particular examples, materials, amounts, and procedures are to be interpreted broadly in accordance with the scope and spirit of the invention as set forth herein.

### Materials

2-diethylaminoethyl methacrylate (DEAEMA); 2-dimethylamino)ethyl methacrylate (DMAEMA); pentaerythritol tetrathioester; tetraethyl orthosilicate (TEOS); ammonium hydroxide (NH₄OH); methyl methacrylate (MMA); 3-aminopropyl)triethoxysilane (APTES); N-[3-(trimethoxysilyl)propyl]ethylenediamine (NPD); chlorotrimethylsilane (TMS), ammonium persulfate (APS), rhodamine isothiocyanate (RITC), purchased from Sigma-Aldrich (St. Louis, MO). Propylene sulphide (PS) purchased from Fisher Scientific, International, Inc. (Hampton, NH). Pluronic F127 purchased from Thermo Fisher Scientific, Inc. (Waltham, MA). 2-[methoxy(polyethyleneoxy)9-12propyl]trimethylsilane (PEG-silane) purchased from Gelest, Inc. (Morrisville, PA). Polyethylene glycol methacrylate (PEGDMA 200) purchased from Polysciences, Inc. (Warrington, PA). Nitrogen phosphorus potassium 20-20-20 Nutriculture general purpose fertilizer purchased from Plant Marvel Laboratories, Inc. (Chicago Heights, IL). Phosphate buffer saline (PBS) purchased from Corning Life Sciences, Inc. (Tewksbury, MA).

pH—Responsive Polymeric Nanoparticles

Swelling polymer core nanoparticles, made from poly-(2-(diethylamino)ethyl methacrylate (pDEAEMA) were synthesized using a free radical polymerization of the 2-aminoethyl methacrylate monomer with PEGDMA as a crosslinker and APS as an initiator as previously described (Hu, et al., Nano Letters, 2007, 7 (10), 3056-3064). The reaction took place in a round bottom flask while purging with nitrogen. Non-swelling control polymeric nanoparticles were synthesized using the same methods but with MMA as a monomer as previously described (Hu, et al., Nano Letters, 2007, 7 (10), 3056-3064). These polymeric nanoparticles were purified via dialysis and ultracentrifugation in PBS.

The size and swelling behavior of pDEAEMA can be adjusted by modifying synthesis temperature and crosslinking density, respectively, as previously described (Tamura, et al., Polymer Journal, 2012, 44 (3), 240-244; Tunc, Y. and Ulubayram, K., Journal of Applied Polymer Science, 2009, 112 (1), 532-540). Additionally, poly-(2-dimethylamino)ethyl methacrylate (pDMAEMA) may be synthesized by a radical polymerization using DMAEMA as a monomer and APS as an initiator in a pH adjusted aqueous solution and purified using dialysis, as previously described (Cherng, et al., Pharmaceutical Research, 1996, 13 (7), 1038-1042; Deirram, et al., Macromolecular Rapid Communications, 2019, 40 (10), 1800917).

### Redox-Responsive Polymeric Nanoparticles

Redox-responsive polymers may be synthesized by an anionic polymerization of PS monomer with Pluoronic F127 as a surfactant, pentaerythritol tetrathioester as an initiator, and an active thiol in a round bottom flask with ultrapure water treated with borax as a base, as previously described (Chauhan, et al., Nanoscale, 2023, 15 (16), 7384-7402; Chauhan, et al., Journal of Applied Polymer Science, 2022, 139 (10), 51767; Reddy, et al., J Control Release, 2006, 112 (1), 26-34).

MPS Coating of pDEAEMA Cores

The MPS shell was formed by adding 3-(trimethoxysilyl)propyl methacrylate (either 28.5 uL or 57 uL) after the 3-hour pDEAEMA polymerization, and the synthesis was continued for 1.5 hours to form pDEAEMA+MPS nanoparticles.

Silica-Coating of pH-Responsive Polymers

pDEAEMA, pDEAEMA+MPS, or pMMA were mixed with water and stirred at 700 rpm and 50° C. TEOS was added dropwise and followed by NH₄OH to catalyze the hydrolysis and condensation of siloxane bonds. In addition to, or in place of, TEOS, alternative silanes such as APTES and NPD can be used to form the silica coating. The solution was stirred for two hours and purified via ultracentrifugation using water and ethanol as centrifugation solvents.

The surface of some nanoparticle systems are modified prior to purification with PEG-silane and TMS as previously described (Lee, et al. ACS Nano, 2017, 11 (6), 5623-5632).

### Determination of Average Hydrodynamic Radius

Hydrodynamic diameters were measured using a Malvern Zetasizer Pro instrument. A 40 μL aliquot of the nanoparticle was diluted in the media of interested and inserted into the instrument to obtain a z-average in nm. For pH-based treatments, size was measured by diluting the nanoparticles sample a specific pH buffer or spiking with a few μL of a strong acid.

### Tomato Plant Greenhouse Study

Tomato seedling leaves were dipped into pDEAEMA nanoparticle suspensions at three concentrations (5,000 ppm, 10,000 ppm, 20,000 ppm). The growth of the tomato plants was observed over a 3-week period and the shoot weight was measured as a metric of polymer nanoparticle biocompatibility

The complete disclosure of all patents, patent applications, and publications, and electronically available material (including, for instance, nucleotide sequence submissions in, e.g., GenBank and RefSeq, and amino acid sequence submissions in, e.g., SwissProt, PIR, PRF, PDB, and translations from annotated coding regions in GenBank and RefSeq) cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A nanoparticle comprising:
a stimulus-responsive polymer core; and
a silica coating disposed on at least a portion of the polymer core.

2. The nanoparticle of claim 1, wherein the stimulus-responsive polymer swells in response to a stimulus.

3. The nanoparticle of claim 1, wherein the stimulus-responsive polymer comprises a pH-responsive polymer, a redox-responsive polymer, a light-responsive polymer, a temperature responsive polymer, or any combination thereof.

4. The nanoparticle of claim 3, wherein the pH-responsive polymer comprises poly(acrylic acid), poly(methacrylic acid), poly(ethacrylic acid), poly(2-dimethylamino)ethyl methacrylate, poly(2-dipropylamino)ethyl methacrylate, poly(2-diisopropylamino)ethyl methacrylate, poly(2-dimethylamino)ethyl acrylate, or any combination thereof.

5. The nanoparticle of claim 3, wherein the redox-responsive polymer comprises polyphenylene sulfide.

6. The nanoparticle of claim 3, wherein the light-response polymer comprises poly(N-isopropylacrylamide) (pNIPAAm) copolymers comprising pendant benzophenone units.

7. The nanoparticle of claim 3, wherein the temperature responsive polymer comprises poly(N-isopropylacrylamide); poly[2-(dimethylamino)ethyl methacrylate] (pDMAEMA); hydroxypropylcellulose; poly(vinylcaprolactam); poly-2-isopropyl-2-oxazoline; polyvinyl methyl ether, or any combination thereof.

8. The nanoparticle of claim 1, further comprises a second coating disposed on the stimulus-responsive polymer core.

9. The nanoparticle of claim 8, wherein at least a portion of the second coating is in direct contact with the stimulus-responsive polymeric core and the silica coating is in direct contact with at least a portion of the second coating.

10. The nanoparticle of claim 1, further comprising at least one species of cargo molecule loaded into or onto the nanoparticle.

11. The nanoparticle of claim 10, wherein the cargo molecule is loaded into the core, incorporated into the silica coating, attached to the surface of the silica coating, or any combination thereof.

12. The nanoparticle of claim 10, wherein the cargo molecules comprises a detectable marker, genetic material, fertilizer, an immunostimulant, or any combination thereof.

13. A composition comprising a plurality of the nanoparticles of claim 1 and a carrier.

14. The composition of claim 14, wherein the carrier comprises a liquid or a solid.

15. A method of preparing the nanoparticle of claim 1, the method comprising:
preparing a polymer core comprising a stimulus-responsive polymer; and
coating at least a portion of the core with a silica coating.

16. A method of delivering silicic acid to a target subject, the method comprising:
administering a nanoparticle to the target subject, the nanoparticle comprising:
a stimulus-responsive polymer core; and
a silica coating disposed on at least a portion of the polymer core;
allowing a stimulus to react with the nanoparticle, thereby causing the polymer core to swell, fracturing the silica shell into fragments comprising silicic acid; and
allowing silicic acid to be released from the fragments.

17. The method of claim 16, wherein the target subject comprises a stimulus to which the stimulus-responsive polymer responds.

18. The method of claim 16, wherein the target subject does not comprise a stimulus to which the stimulus-responsive polymer responds and wherein the method further comprises providing a stimulus to which the stimulus-responsive polymer responds.

19. The method of claim 16, wherein the stimulus is pH, redox potential, temperature, or light.

20. The method of claim 16, wherein the target subject is a plant and wherein administering a nanoparticle to the target subject comprises administering the nanoparticles or composition containing the same to the plant, a media in contact with the plant, or both.
